(19) United States
(12) Patent Application Publication
(10) Pub. No.: US 2025/0148564 A1
(43) Pub. Date: May 8, 2025

(54) MUSIC CARD

(71) Applicant: HAYNIE O'NEAL SMITH, II, MilWaukee, WI (US)

(72) Inventor: HAYNIE O'NEAL SMITH, II, MilWaukee, WI (US)

(21) Appl. No.: 17/897,569

(22) Filed: Aug. 29, 2022

(51) Int. Cl. G06Q 90/00

(52) U.S. Cl. CPC G06Q 90/00

(57) ABSTRACT

The Music Card is a ready for purchase plastic card that directs customers to access digital full-length albums, singles, or EP' by specific artists; functioning like a vinyl album, CD, Cassettes, by showing in the front; the artist name, album cover, and recording/distribution company. On the back, it shows song titles from the album, UPC Barcode, Explicit Content Warning label, purchase price recording/distribution label, how to access album digitally and scratch off download code. It is used like a prepaid gift card and stores information available for download on all internet connected electronic devices. Manually type in URL, or scan QR code under scratch off, proceed to online checkout. When code is entered, the price will mark down. After completion, the download link and sales notification will go to the customer's email available for only 30 days.

The Music Card is a retail ready plastic hanging card. The Music card directs customers to access digital full-length albums, singles, EPs, or PDF Books. After purchasing the Music Card at any retail store. It is used like a prepaid gift card but functions and store information such as books, physical albums, EP, CD's, for all music artists and for all genres or music. The Music Card includes the name of the artist/author name/title of the album/book, album or book artwork, artist/author name logo, Recording Label/Distributor/Publisher name or logo, album tracklisting, parental advisory logo if needed, website, access code, scratch off, QR code, price of the Music Card, UPC Barcode for sales tracking, and also has space available to include an optional year of release. The Music Card is a unique tool to see, purchase, displace copies in stores, download music and PDF books on all devices connected to the internet browser, track Music Album, EP, and digital Book retail sales while storing the audio files online. The Music Card is plastic 3×5 affordable for manufactures, easy to handle for distributors and merchandisers, space saving for sellers, has a unique code concealed under the scratch off for security purposes. After the Music Card is purchased from the retailer. The customer can choose the option to manually type in the website where the album, EP or book is located in a zip file on the record label/artist website or storage drive Or, scan the QR Code on the Music Card and go directly online where the album is located, enter unique code under scratch off and proceed to online store checkout. After the code is entered online. The price will be marked down to the retail paid price. After the customer submits an email address, the album, EP, or book zip file will be ready for download on iPhone, iMac computers, Macbooks, PC, Laptop, Android, Google, Safari, and all other devices with an available internet browser. After the online required information is complete purchase notification will go to both the customer and the website domain owner's email for inventory purposes. The download link will also go to the customer's email where it will be stored for only 30 days. The music Card can be saved as memorabilia, and has the option to be reused or non reuseable by the purchaser.

### BRIEF DESCRIPTION OF THE DRAWINGS

FIG. 1 illustrates the front of the Music Card.

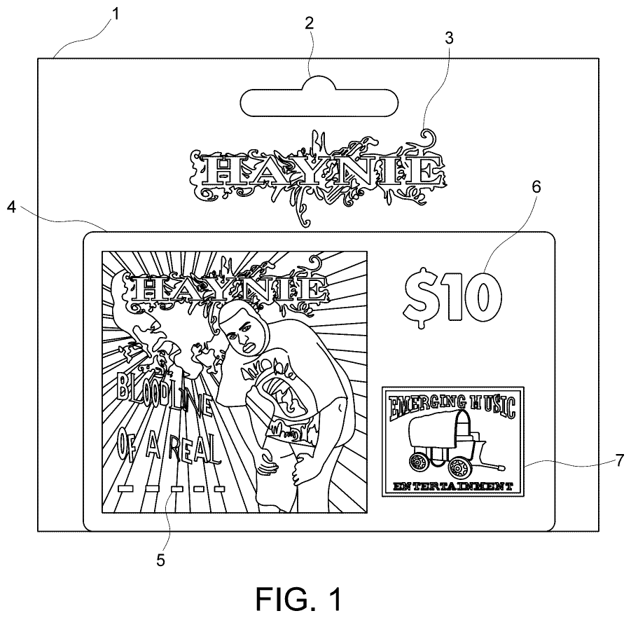

FIG. 2 illustrates the back of the Music Card.

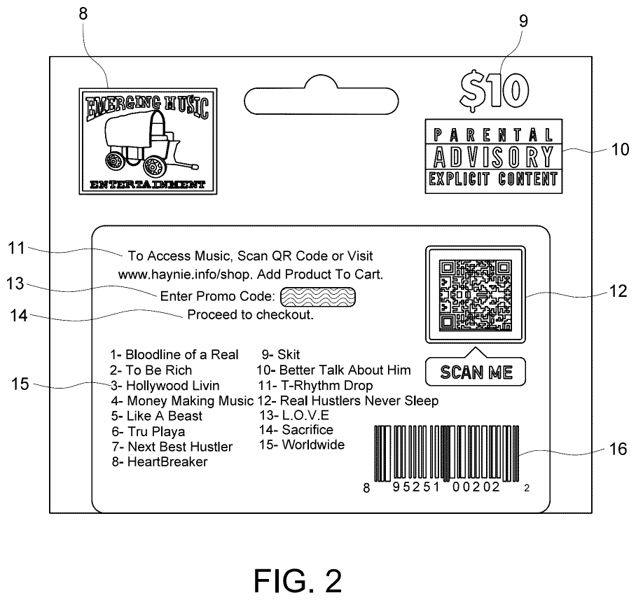

1. I Haynie O'Neal Smith II claims ownership of The Music Card and all figures as a collective in specifications Drawing 1 (Front) and Drawing 2 (Back).
